(19) United States
(12) Patent Application Publication
(10) Pub. No.: US 2012/0133138 A1
(43) Pub. Date: May 31, 2012

(54) PLANT POWER OPTIMIZATION

(75) Inventors: Søren Sørensen, Aarhus N (DK); Martin Ansbjerg Kjær, Harlev J (DK)

(73) Assignee: VESTAS WIND SYSTEMS A/S, Aarhus N (DK)

(21) Appl. No.: 13/334,956

(22) Filed: Dec. 22, 2011

(51) Int. Cl. H02P 9/04

(52) U.S. Cl. 290/44

(57) ABSTRACT

Embodiments of the invention are generally related to optimizing performance of a wind power plant. A controller may be configured to determine that a first wind turbine is in the wake of a second wind turbine and that power production at the first wind turbine can be increased by reducing power production at the second wind turbine. The controller may be further configured to cause the second wind turbine to reduce power production.

### FIELD OF THE INVENTION

Embodiments of the invention generally relate to wind turbine farms, and more specifically to improving the performance of wind turbine farms.

### BACKGROUND

In recent years, there has been an increased focus on reducing emissions of greenhouse gases generated by burning fossil fuels. One solution for reducing greenhouse gas emissions is developing renewable sources of energy. Particularly, energy derived from the wind has proven to be an environmentally safe and reliable source of energy, which can reduce dependence on fossil fuels.

Energy in wind can be captured by a wind turbine, which is a rotating machine that converts the kinetic energy of the wind into mechanical energy, and the mechanical energy subsequently into electrical power. Common horizontal-axis wind turbines include a tower, a nacelle located at the apex of the tower, and a rotor that is supported in the nacelle by means of a shaft. The shaft couples the rotor either directly or indirectly with a rotor assembly of a generator housed inside the nacelle. A plurality of wind turbines generators may be arranged together in a wind farm/park or wind power plant to generate sufficient energy to support a grid.

In general each turbine in a wind farm is configured to extract maximum possible energy from the wind. When wind turbines are lined up one behind another in relation to the wind direction, it is likely that the first turbine will extract the maximum possible energy from the wind. The remaining turbines behind the first turbine will extract relatively less power because they are in the wake of the first turbine.

### SUMMARY OF THE INVENTION

Embodiments of the invention generally relate to wind turbine farms, and more specifically to improving the performance of wind turbine farms.

One embodiment of the invention provides a method for regulating power production in a wind farm. The method generally comprises determining that a first wind turbine is in the wake of a second wind turbine, and determining that power production at the first wind turbine can be increased by reducing power production at the second wind turbine. The method further comprises generating a request that the second wind turbine reduce power production, and in response to the request, reducing power production by the second turbine by a predefined amount.

Another embodiment of the invention provides a wind power plant, comprising a plurality of wind turbines, and a controller. The controller is generally configured to determine that a first wind turbine of the plurality of wind turbines is in the wake of a second wind turbine, determine that power production at the first wind turbine can be increased by reducing power production at the second wind turbine, and generate a request that the second wind turbine reduce power production. The second wind turbine is configured to reduce power production by a predefined amount in response to the request.

Yet another embodiment of the invention provides a wind turbine controller, configured to receive a request from a first wind turbine of a plurality of wind turbine of a wind park to increase power production, and determine that the first wind turbine is in the wake of a second wind turbine. The wind turbine controller is further configured to determine that power production at the first wind turbine can be increased by reducing power production at the second wind turbine, and generate a power reference signal to the second wind turbine to reduce power production at the second wind turbine.

### BRIEF DESCRIPTION OF THE DRAWINGS

Embodiments of the present invention are explained, by way of example, and with reference to the accompanying drawings. It is to be noted that the appended drawings illustrate only examples of embodiments of this invention and are therefore not to be considered limiting of its scope, for the invention may admit to other equally effective embodiments.

FIG. 1 illustrates an exemplary wind turbine according to an embodiment of the invention.

FIG. 2 illustrates an exemplary wind turbine nacelle according to an embodiment of the invention.

FIG. 3 illustrates an exemplary wind power plant control system according to an embodiment of the invention.

FIG. 4 illustrates an exemplary wind farm according to an embodiment of the invention.

FIG. 5 illustrates an exemplary wind turbine computer according to an embodiment of an invention.

FIG. 6 illustrates an exemplary wind farm according to an embodiment of the invention.

FIG. 7 is a flow diagram of exemplary operations performed to manage power production in a wind farm, according to an embodiment of the invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention.

Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The following is a detailed description of embodiments of the invention depicted in the accompanying drawings. The embodiments are examples and are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims.

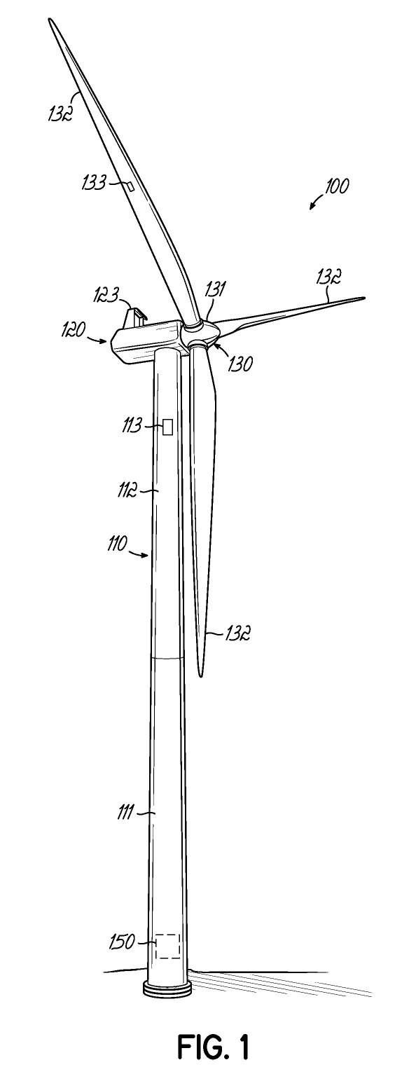

FIG. 1 illustrates an exemplary wind turbine 100 according to an embodiment of the invention. As illustrated in FIG. 1, the wind turbine 100 includes a tower 110, a nacelle 120, and a rotor 130. In one embodiment of the invention, the wind turbine 100 may be an onshore wind turbine. However, embodiments of the invention are not limited only to onshore wind turbines. In alternative embodiments, the wind turbine 100 may be an off shore wind turbine located over a water body such as, for example, a lake, an ocean, or the like.

The tower 110 of wind turbine 100 may be configured to raise the nacelle 120 and the rotor 130 to a height where strong, less turbulent, and generally unobstructed flow of air may be received by the rotor 130. The height of the tower 110 may be any reasonable height. The tower 110 may be made from any type of material, for example, steel, concrete, or the like. In some embodiments the tower 110 may be made from a monolithic material. However, in alternative embodiments, the tower 110 may include a plurality of sections, for example, two or more tubular steel sections 111 and 112, as illustrated in FIG. 1. In some embodiments of the invention, the tower 110 may be a lattice tower. Accordingly, the tower 110 may include welded steel profiles.

The rotor 130 may include a rotor hub (hereinafter referred to simply as the “hub”) 131 and at least one blade 132 (three such blades 132 are shown in FIG. 1). The rotor hub 131 may be configured to couple the at least one blade 132 to a shaft (not shown). In one embodiment, the blades 132 may have an aerodynamic profile such that, at predefined wind speeds, the blades 132 experience lift, thereby causing the blades to radially rotate around the hub. The nacelle 120 may include one or more components configured to convert aero-mechanical energy of the blades to rotational energy of the shaft, and the rotational energy of the shaft into electrical energy.

The wind turbine 100 may include a plurality of sensors for monitoring a plurality of parameters associated with, for example, environmental conditions, wind turbine loads, performance metrics, and the like. For example, a strain gauge 133 is shown on the blade 132. In one embodiment, the strain gauge 133 may be configured to detect bending and or twisting of the blades 132. The information regarding bending and twisting of the blades may be necessary to perform one or more operations that reduce the loads on the blades 132 that may occur, for example, due to high wind gusts, wake generated turbulence, wake meandering, and the like. In such situations, the blades may be pitched to reduce the loads, thereby preventing damage to the blades.

FIG. 1 also illustrates an accelerometer 113 that may be placed on the tower 110. The accelerometer 113 may be configured to detect horizontal movements and bending of the tower 110 that may be caused due to the loads on the wind turbine 100. The data captured by the accelerometer 113 may be used to perform one or more operations for reducing loads on the wind turbine 100. In some embodiments of the invention, the accelerometer 113 may be placed on the nacelle 120.

FIG. 1 also depicts a wind sensor 123. Wind sensor 123 may be configured to detect a direction of the wind at or near the wind turbine 100. By detecting the direction of the wind, the wind sensor 123 may provide useful data that may determine operations to yaw the wind turbine 100 into the wind. The wind sensor 123 may use the speed and direction of the wind to control blade pitch angle. Wind speed data may be used to determine an appropriate pitch angle that allows the blades 132 to capture a desired amount of energy from the wind or to avoid excessive loads on turbine components. In some embodiments, the wind sensor 123 may be integrated with a temperature sensor, pressure sensor, and the like, which may provide additional data regarding the environment surrounding the wind turbine. Such data may be used to determine one or more operational parameters of the wind turbine to facilitate capturing of a desired amount of energy by the wind turbine 100 or to avoid damage to components of the wind turbine.

In one embodiment of the invention, a light detection and ranging (LIDAR) device 180 may be provided on or near the wind turbine 100. For example, the LIDAR 180 may be placed on a nacelle, hub, and/or tower of the wind turbine, as illustrated in FIG. 1. In alternative embodiments, the LIDAR 180 may be placed in one or more blades 132 of the wind turbine 100. In some other embodiments, the LIDAR device may be placed near the wind turbine 100, for example, on the ground as shown in FIG. 1. In general, the LIDAR 180 may be configured to detect wind speed and/or direction at one or more points in front of the wind turbine 100. In other words, the LIDAR 180 may allow the wind turbine to detect wind speed before the wind actually reaches the wind turbine. This may allow wind turbine 100 to proactively adjust one or more of blade pitch angle, yaw position, and like operational parameters to capture greater energy from the wind, and reduce loads on turbine components. In some embodiments, a controller may be configured to combine the data received from a LIDAR device 180 and the wind sensor 123 to generate a more accurate measure of wind speed and/or direction.

While a strain gauge 133, accelerometer 113, and wind sensor 123 are described herein, embodiments of the invention are not limited to the aforementioned types of sensors. In general, any type and number of sensors may be placed at various locations of the wind turbine 100 to facilitate capturing data regarding structural health, performance, damage prevention, acoustics, and the like. For example, a pitch angle sensor may be placed at or near a wind turbine blade to determine a current pitch angle of the blade.

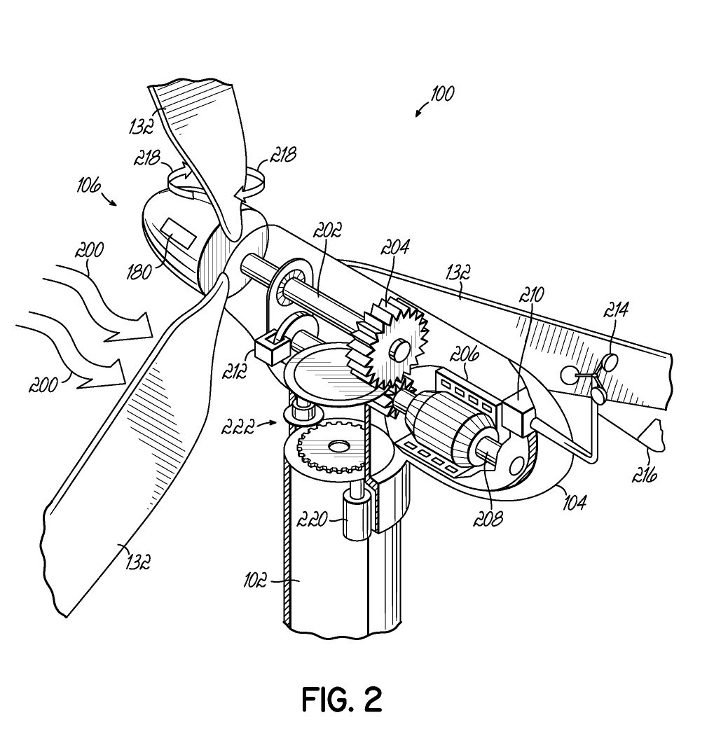

FIG. 2 illustrates a diagrammatic view of typical components internal to the nacelle 120 and tower 110 of a wind turbine generator 100. When the wind 200 pushes on the blades 132, the rotor 130 spins, thereby rotating a low-speed shaft 202. Gears in a gearbox 204 mechanically convert the low rotational speed of the low-speed shaft 202 into a relatively high rotational speed of a high-speed shaft 208 suitable for generating electricity using a generator 206. In an alternative embodiment, the gear box may be omitted, and a single shaft, e.g., the shaft 202 may be directly coupled with the generator 206.

A turbine computer or controller 210 may sense the rotational speed of one or both of the shafts 202, 208. If the controller decides that the shaft(s) are rotating too fast, the controller may signal a braking system 212 to slow the rotation of the shafts, which slows the rotation of the rotor 106, in turn. The braking system 212 may prevent damage to the components of the wind turbine generator 100. The turbine controller 210 may also receive inputs from an anemometer 214 (providing wind speed) and/or a wind vane 216 (providing wind direction). Based on information received, the controller 210 may send a control signal to one or more of the blades 108 in an effort to adjust the pitch 218 of the blades. By adjusting the pitch 218 of the blades with respect to the wind direction, the rotational speed of the rotor (and therefore, the shafts 202, 208) may be increased or decreased. Based on the wind direction, for example, the controller 210 may send a control signal to an assembly comprising a yaw motor 220 and a yaw drive 222 to rotate the nacelle 104 with respect to the tower 102, such that the rotor 106 may be positioned to face more (or, in certain circumstances, less) upwind.

The generator 206 may be configured to generate a three phase alternating current based on one or more grid requirements. In one embodiment, the generator 206 may be a synchronous generator. Synchronous generators may be configured to operate at a constant speed, and may be directly connected to the grid. In some embodiments, the generator 206 may be a permanent magnet generator. In alternative embodiments, the generator 206 may be an asynchronous generator, also sometimes known as an induction generator. Induction generators may or may not be directly connected to the grid. For example, in some embodiments, the generator 206 may be coupled to the grid via one or more electrical devices configured to, for example, adjust current, voltage, and other electrical parameters to conform with one or more grid requirements. Exemplary electrical devices include, for example, inverters, converters, resistors, switches, transformers, and the like.

Embodiments of the invention are not limited to any particular type of generator or arrangement of the generator and one or more electrical devices associated with the generator in relation to the electrical grid. Any suitable type of generator including (but not limited to) induction generators, permanent magnet generators, synchronous generators, or the like, configured to generate electricity according to grid requirements falls within the purview of the invention.

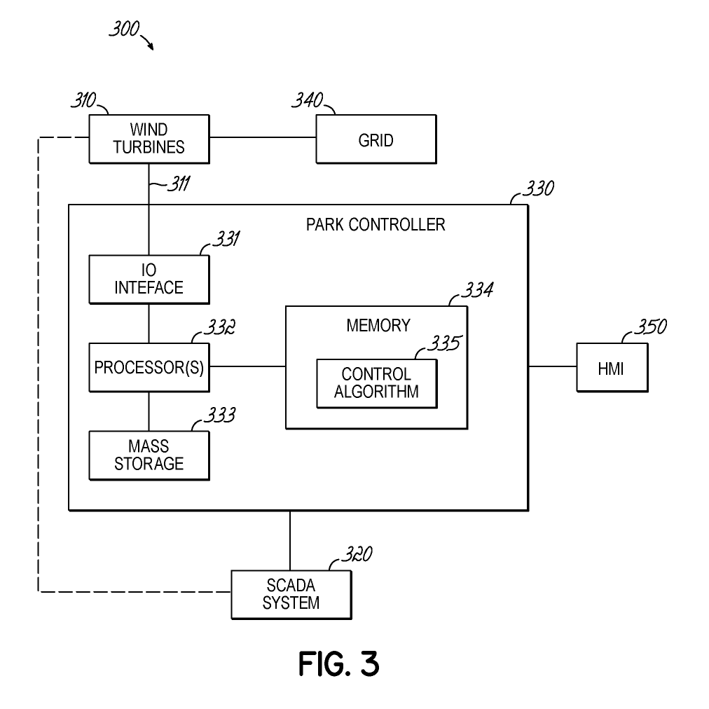

FIG. 3 illustrates an exemplary wind power plant 300 according to an embodiment of the invention. As illustrated, the wind power plant 300 may include a wind farm 310 coupled with a grid 340, a park controller 330, and a Supervisory Control and Data Acquisition (SCADA) system 320. The wind farm 310 may include one or more wind turbines, such as the representative wind turbine 100. The wind turbines collectively act as a generating plant ultimately interconnected by transmission lines with a power grid 340, which may be a three-phase power grid. The plurality of turbines of wind farm 310 may be gathered together at a common location in order to take advantage of the economies of scale that decrease per unit cost with increasing output. It is understood by a person having ordinary skill in the art that the wind farm 310 may include an arbitrary number of wind turbines of given capacity in accordance with a targeted power output.

The power grid 340 generally consists of a network of power stations, transmission circuits, and substations coupled by a network of transmission lines. The power stations generate electrical power by nuclear, hydroelectric, natural gas, or coal fired means, or with another type of renewable energy like solar and geothermal. Additional wind farms analogous to the wind farm 310 depicted may also be coupled with the power grid 340. Power grids and wind farms typically generate and transmit power using Alternating Current (AC).

The controller 330 can be implemented using one or more processors 331 selected from microprocessors, micro-controllers, digital signal processors, microcomputers, central processing units, field programmable gate arrays, programmable logic devices, state machines, logic circuits, analog circuits, digital circuits, and/or any other devices that manipulate signals (analog and/or digital) based on operational instructions that are stored in a memory 334. In one embodiment of the invention, the controller 330 may be configured to generate a power reference signals to each of the wind turbines in the wind farm 310. Based on the power reference signals 311 the wind turbines in the wind farm 310 may adjust one or more operational parameters, e.g., blade pitch angles, so that the wind farm produces a desired amount of power.

Memory 334 may be a single memory device or a plurality of memory devices including but not limited to read-only memory (ROM), random access memory (RAM), volatile memory, non-volatile memory, static random access memory (SRAM), dynamic random access memory (DRAM), flash memory, cache memory, and/or any other device capable of storing digital information.

Mass storage device 333 may be a single mass storage device or a plurality of mass storage devices including but not limited to hard drives, optical drives, tape drives, non-volatile solid state devices and/or any other device capable of storing digital information. An Input/Output (I/O) interface 331 may employ a suitable communication protocol for communicating with the wind turbines of wind farm 310.

Processor 332 operates under the control of an operating system, and executes or otherwise relies upon computer program code embodied in various computer software applications, components, programs, objects, modules, data structures, etc. to read data from and write instructions to one or more wind turbines of wind farm 310 through I/O interface 331, whether implemented as part of the operating system or as a specific application.

A human machine interface (HMI) 350 is operatively coupled to the processor 332 of the controller 330 in a known manner. The HMI 350 may include output devices, such as alphanumeric displays, a touch screen, and other visual indicators, and input devices and controls, such as an alphanumeric keyboard, a pointing device, keypads, pushbuttons, control knobs, etc., capable of accepting commands or input from the operator and transmitting the entered input to the processor 332.

As stated above, if a plurality of wind turbines are lined up one behind another in relation to the wind direction, the first turbine in the row may be capable of producing the highest amount of power because it received the full force of the wind. The remaining turbines may be in the wind shadow, or wake, of the first turbine. Because the first turbine extracts energy from the wind, the remaining turbines may not be able to produce as much power as the first turbine because they may experience lower wind speeds. Furthermore, the interaction of the wind with an up-wind turbine may cause a significant amount of turbulence in the wind that reaches down-wind turbines. Because such turbulence can cause increased loads on the components, the down wind turbines have to further de-rate power production. Such losses in ability to produce the maximum amount of power are commonly referred to as wake losses.

In general, most turbines are configured to extract as much power from the wind as may be possible. However, in the aforementioned example, the first turbine may generate the greatest amount of power during its lifetime. However, this also means that the remaining turbines may be under-utilized. Accordingly, it may be advantageous to reduce the power production from the first turbine to allow greater use and production from the remaining turbines in a row. Embodiments of the invention propose methods for managing the production of power from each turbine in a wind park so that the maximum amount of energy can be generated by the wind park as a whole.

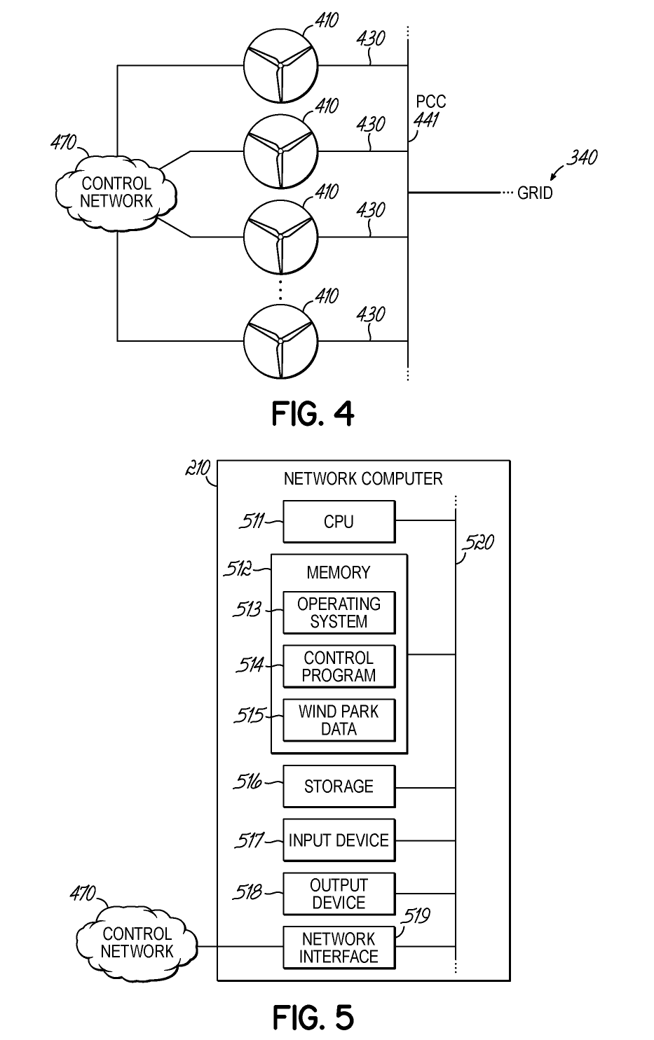

FIG. 4 illustrates is a more detailed view of the wind farm 310 according to an embodiment of the invention. As illustrated in FIG. 4, the wind farm 310 may include a plurality of wind turbine generators 410 (four such wind turbine generators 310 are shown) coupled with the grid 340 via transmission lines 430. In one embodiment, each of the transmission lines 430 may include a set of three lines for transferring a three phase alternating current according to one or more requirements of the grid 340. For example, the wind turbine generators 410 may be configured to provide power at a controlled frequency and voltage to the grid. As illustrated in FIG. 4, the transmission lines 430 from the wind turbine generators 410 may be coupled with the grid at a point of common coupling (PCC) 441. While not shown in FIG. 4, in some embodiments, PCC 441 may include one or more electrical devices, for example, transformers, switches, and the like.

As illustrated in FIG. 4, the wind turbines 410 may be coupled to a control network 470. In general, the control network 470 may be a local area network connecting the wind turbines 410 in a wind park. In one embodiment, the control network 470 may be a wired network comprising, for example, Ethernet and/or twisted pair cabling. In an alternative embodiment, the control network 470 may be a wireless network based on, for example, the IEEE 802.11 standards. However, other wireless communication protocols may also be implemented in other embodiments. In some embodiments, the control network 470 may include a combination of one or more interconnected wireless and/or wired networks.

In one embodiment of the invention, the network 470 may be a broadcast network. Accordingly, data may be sent from one turbine to every other turbine in the wind park. In an alternative embodiment, data may be sent from one turbine to only selected few turbines. In one embodiment, each turbine of a wind park may be directly connected to every other turbine in the wind park. Alternatively, each turbine may be connected to one or more adjacent turbines. In such networks, transferring data from one turbine to another turbine may involve transferring the data through one or more intermediate turbines.

In one embodiment of the invention, a turbine controller or computer 210 (see FIG. 2) of each wind turbine 410 may be configured to couple the respective wind turbine to the control network 470. Such coupling of the wind turbines 410 may facilitate the exchange of control information between the wind turbines 410 of a wind park, as will be discussed in greater detail below.

FIG. 5 depicts a block diagram of a turbine controller or computer 210, according to an embodiment of the invention. The controller 210 may include a Central Processing Unit (CPU) 511 connected via a bus 520 to a memory 512, storage 516, an input device 517, an output device 518, and a network interface device 519.

The input device 517 can be any device to give input to the controller 210. In one embodiment, the input device 517 may be coupled with one or more sensors of a wind turbine, for example, the sensors 113, 123, and 133 of FIG. 1. In some embodiments, the input device 517 may be configured to receive user input. According, the input device 517 may be a keyboard, keypad, light-pen, touch-screen, track-ball, or speech recognition unit, audio/video player, or the like.

The output device 518 can be any device to give output to a user, e.g., any conventional display screen. In some embodiments, the output device may be a device configured to set off an alarm, for example, by flashing emergency lights, setting off an audible alarm, sending text or electronic messages to predefined persons, etc. The network interface device 519 may be any entry/exit device configured to allow network communications between a plurality of controllers 210 via the network 470. For example, the network interface device 519 may be a network adapter or other network interface card (NIC).

Storage 516 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 512 and storage 516 could be part of one virtual address space spanning multiple primary and secondary storage devices.

The memory 512 is preferably a random access memory sufficiently large to hold the necessary programming and data structures of the invention. While memory 512 is shown as a single entity, it should be understood that memory 512 may in fact comprise a plurality of modules, and that memory 512 may exist at multiple levels, from high speed registers and caches to lower speed but larger DRAM chips.

Illustratively, the memory 512 contains an operating system 513. Illustrative operating systems, which may be used to advantage, include Linux (Linux is a trademark of Linus Torvalds in the US, other countries, or both) and Microsoft's Windows®. More generally, any operating system supporting the functions disclosed herein may be used.

Memory 512 is also shown containing a control program 414 which, when executed by CPU 511, provides support for exchanging control data between wind turbines. In one embodiment, exchanging control data between wind turbines in a wind park may allow the wind turbines of the wind park to regulate capture of energy. For example, control data that is captured or derived at one wind turbine may be transferred to one or more other turbines, which may preemptively adjust one or more operational parameters to capture more energy from the wind, prevent damage to the turbine, reduce loads, improve performance, and the like.

The memory 512 may also include wind park data 515. Wind park data 515 may include information regarding the specific number and types of turbines within the wind park, their status (e.g., active, not active, fault), location, proximity, and the like. While wind park data 515 is shown herein as a part of the memory 512, in alternative embodiments, the wind park data may also exist at other locations, e.g., within the memory 334 of the park controller 330 (see FIG. 3).

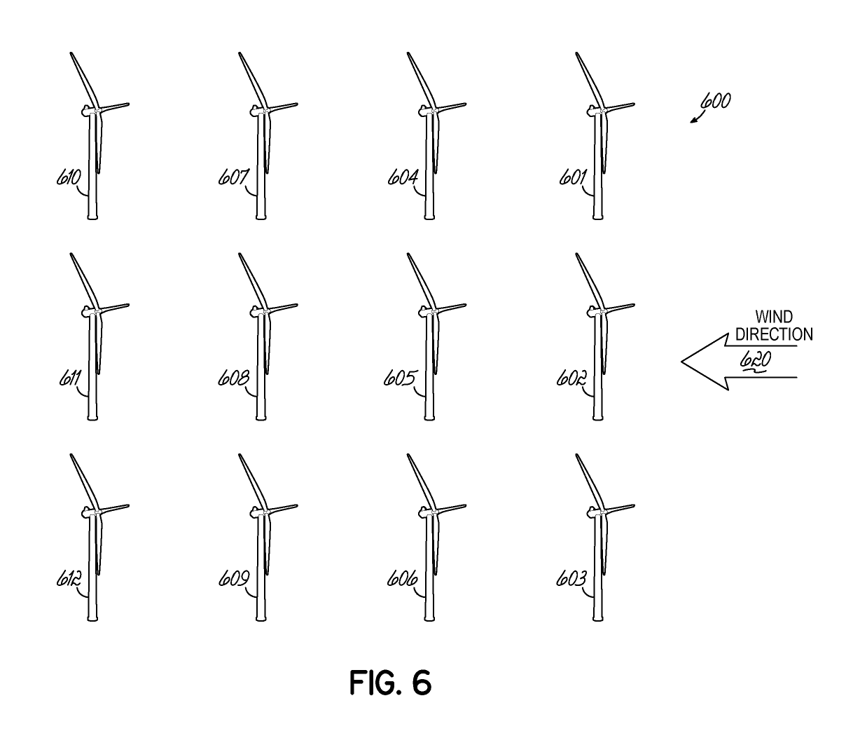

In one embodiment of the invention, one or more of the controllers, e.g., the turbine controller 210 or the park controller 330 (or a combination of the two) may be configured to perform operations that regulate power production from the plurality of wind turbines in a wind farm such that power production from the wind farm is maximized and/or the loads on the wind turbine components is balanced. An exemplary wind farm 600 is shown in FIG. 6 to describe exemplary operations that may be performed by the controllers. As illustrated in FIG. 6, wind farm 600 may include a plurality of wind turbines 601-612. The turbines 601-612 are connected to each other via a control network, for example, the control network 470 illustrated in FIG. 4.

FIG. 6 also indicates the wind direction 620. Based on the wind direction 620, the wind turbines 601-603 may be the first wind turbines in line of the wind. Therefore, wind turbines 601-603 are likely to capture the greatest amount of energy from the wind. Because turbines 601-603 extract energy from the wind, the remaining turbines 604-612 may be progressively less amount of energy available to extract from the wind. Furthermore, because up wind turbines 601-603 interact with the wind, the wind reaching the turbines 604-612 may be become progressively more and more turbulent. Accordingly, the turbines 604-612 may have to de-rate power production to prevent components from being damaged. Embodiments of the invention provide methods for regulating capture of energy from wind such that the maximum amount of power is generated by the wind farm, and such that the loads on the wind turbines are balanced.

In one embodiment, a controller may determine that one or more turbines are being underutilized. For example, a park controller 330 or wind turbine controller 210 of a first turbine may determine that it is in the wake or wind shadow of a second turbine, and therefore is unable to capture more power from the wind. Alternatively, the controller may receive, from a sensor, an indication of the turbulence level in the wind, and determine that the turbulence level is beyond a threshold limit. If the turbulence level is beyond the threshold limit, the controller may de-rate an associated wind turbine. In one embodiment, a request may be generated to the second wind turbine, requesting that the second wind turbine reduce power production, thereby allowing the second wind turbine to increase production. Specifically, reducing power production at the second turbine may reduce the turbulence level experienced by the first wind turbine, and may increase the wind energy available to the first turbine. Reducing turbulence levels experienced by the first turbine may reduce the loads on the first turbine, thereby obviating the need to de-rate the first turbine and thereby allowing increased power production therefrom.

For example, referring to FIG. 6, suppose turbine 605 determines that it is in the wake of turbine 602, and that power production at the turbine 605 can be increased based on wind conditions near the wind park. In one embodiment, the turbine 605 may generate a request to reduce power production to wind turbine 602. The request may be transferred to the turbine 602 via the control network 470. The wind turbine 602 may receive the request and reduce power production by a predefined or requested amount. The turbine 602 may be configured to periodically check whether the request from turbine 605 is active. If the request is deemed to be active, turbine 605 may continue to operate in a reduced power mode. If the request is no longer active, turbine 602 may return to increased power production. Checking whether a request for reduced power production may involve the exchange of one or more messages between the relevant turbines via the control network.

In one embodiment of the invention, reduced power production by a turbine may be maintained only if the overall effect of the reduction results in increased production of power from the wind park and/or overall reduction in loads experienced by the relevant turbine. For example, in one embodiment, after reducing power production turbine 602 may check back with the turbine 605 regarding the increase in power production therefrom. If the increase in power production by the turbine 605 is not greater than the reduction in power production from turbine 602, then turbine 602 may return to maximum energy production.

While regulating power production by wind turbines communicating with each other via a control network is disclosed hereinabove, in alternative embodiment a centralized control, e.g., a park controller 330 may manage the power production by the turbines in a wind park. For example, the park controller may be configured to receive messages (via the control network) from the turbine 605, the messages indicating that increased production from the turbine is possible. In response to receiving such messages, the park controller may determine whether the requesting turbine is in the wake of another turbine. Upon determining that the turbine 605 is in the wake of turbine 602, the park controller may adjust a power reference signal to wind turbine 602, thereby adjusting power production therefrom. In one embodiment, the park controller may be configured to adjust power production from a wind turbine only if it is determined that the adjustment will result in an overall improvement in power production from the wind farm and/or improved load balancing between the turbines.

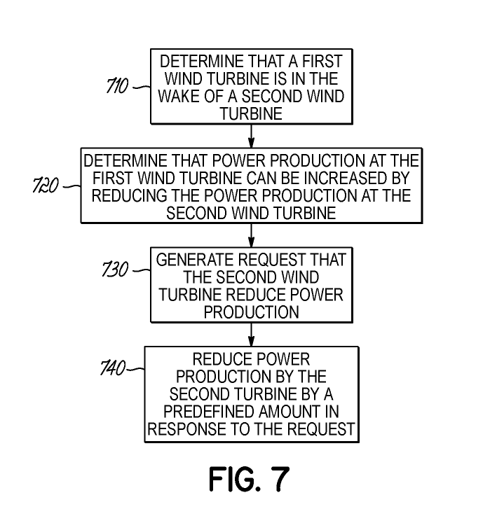

FIG. 7 is a flow diagram of exemplary operations performed by a controller according to an embodiment of the invention. The operations may begin in step 710 by determining that a first wind turbine operating in a de-rated power mode is in the wake of a second wind turbine. In step 720, it may be determined that power production at the first wind turbine can be increased by reducing power production at the second wind turbine. In step 730, a request that the second wind turbine reduce power production may be generated. In step 740, power production by the second turbine may be reduced by a predefined amount in response to the request.

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

What is claimed is:

1. A method for regulating power production in a wind farm, comprising:
determining that a first wind turbine operating in a de-rated power mode is in the wake of a second wind turbine;
determining that power production at the first wind turbine can be increased by reducing power production at the second wind turbine;
generating a request that the second wind turbine reduce power production;
in response to the request, reducing power production by the second turbine by a predefined amount; and
increasing power production from the first wind turbine.

2. The method of claim 1, wherein the power production at the second wind turbine is reduced only upon determining that the reduction results in at least one of:
improves overall production of power from the wind farm; and
achieves improved balancing of turbine loads between one or more turbines in the wind park.

3. The method of claim 1, wherein the request is generated by the first turbine and transferred to the second turbine via a control network connecting the first turbine to a second turbine.

4. The method of claim 1, wherein the request is generated by the first turbine to a wind farm controller.

5. The method of claim 4, wherein the wind farm controller is configured to adjust a power reference signal to the second wind turbine to reduce power production from the second wind turbine.

6. A wind power plant, comprising:
a plurality of wind turbines; and
a controller configured to:
determine that a first wind turbine of the plurality of wind turbines is in the wake of a second wind turbine, the first turbine operating in a de-rated power mode;
determine that power production at the first wind turbine can be increased by reducing power production at the second wind turbine;
generate a request that the second wind turbine reduce power production, wherein the second wind turbine is configured to reduce power production by a predefined amount in response to the request; and
increase power production from the first wind turbine.

7. The wind power plant of claim 6, wherein the power production at the second wind turbine is reduced by the controller only upon determining that the reduction results in at least one of:
improved overall production of power from the wind farm; and
improved balancing of turbine loads between one or more of the plurality of wind turbines.

8. The wind power plant of claim 6, wherein the controller is a wind turbine controller of the first turbine and transferred to the second turbine via a control network connecting the first turbine to a second turbine.

9. The wind power plant of claim 6, wherein the controller is a park controller, and wherein the request is generated by the first turbine to the park controller.

10. The wind power plant of claim 9, wherein the park controller is configured to adjust a power reference signal to the second wind turbine to reduce power production from the second wind turbine.

11. A wind turbine controller, configured to:
receive a request from a first wind turbine of a plurality of wind turbine of a wind park to increase power production, the first wind turbine operating in a de-rated power mode;
determine that the first wind turbine is in the wake of a second wind turbine;
determine that power production at the first wind turbine can be increased by reducing power production at the second wind turbine;
generate a power reference signal to the second wind turbine to reduce power production at the second wind turbine; and
increase power production from the first wind turbine.

12. The wind turbine controller of claim 11, wherein the power production at the second wind turbine is reduced by the wind turbine controller only upon determining that the reduction results in at least one of:
improved overall production of power from the wind farm; and
improved balancing of turbine loads between one or more of the plurality of wind turbines.

13. The wind turbine controller of claim 11, wherein the wind park controller and the plurality of wind turbines are connected to each other via a control network.

14. The wind turbine controller of claim 13, wherein the request from the first turbine is received via the control network.

15. The wind turbine controller of claim 11, wherein the power reference signal is transferred to the second turbine via the control network.

16. The wind turbine controller of claim 11, wherein the first wind turbine is operated in a de-rated power mode in response to determining that wind turbulence experienced by the first wind turbine is above a threshold level, and wherein reducing power production at the second wind turbine reduces the wind turbulence experienced by the first wind turbine.
